(19) United States
(12) Patent Application Publication
(10) Pub. No.: US 2011/0161499 A1
(43) Pub. Date: Jun. 30, 2011

(54) NETWORK ADDRESS TRANSLATION METHOD, NETWORK ADDRESS TRANSLATOR, AND COMMUNICATION SYSTEM FOR MEDIA STREAMING

(75) Inventor: Yi-Ping Tsai, Taoyuan County (TW)

(73) Assignee: GEMTEK TECHNOLOGY CO., LTD., Hukou (TW)

(21) Appl. No.: 12/770,035

(22) Filed: Apr. 29, 2010

(30) Foreign Application Priority Data
Dec. 29, 2009 (TW) 098145521

(51) Int. Cl. G06F 15/16

(52) U.S. Cl. 709/227; 709/231; 709/245

(57) ABSTRACT

A network address translation method includes: configuring a network address translator (NAT) to receive a first control signal from a first user end indicating an intent to conduct media streaming, a media description in the first control signal including a private first address and a private first port; configuring the NAT to modify the first address and the first port to a public second address and a public second port, and to send a second control signal containing a media description that includes the second address and the second port to a control signal server; and configuring the NAT to receive a third control signal sent in response from a second user end via the control signal server, parse a media description in the third control signal to obtain a public third address and a public third port, and establish an address translation rule using the addresses and ports.

### CROSS-REFERENCE TO RELATED APPLICATION

This application claims priority of Taiwanese Application No. 098145521, filed on Dec. 29, 2009.

### BACKGROUND OF THE INVENTION

1. Field of the Invention

The present invention relates to a network address translation method, a network address translator, and a communication system for media streaming.

2. Description of the Related Art

There are many different types of media streaming applications, including voice over Internet protocol (VOIP), fax over Internet protocol (FOIP), etc. However, since allocations of IP network addresses of IPv4 (Internet Protocol version 4) are insufficient to meet demand, users must use network address translators (NATs) employing network address translation technology to obtain additional private IP network addresses. Moreover, through use of NATs, internal private addresses and ports are translated to public network addresses and ports, such that the users of the private IP network addresses can have normal connection to the Internet. Therefore, network address translation technology is widely used. However, network address translation technology also causes some problems due to the fact that only the network addresses of the IP layer headers are changed with the use of this technology, while the address information in the application layer is not correspondingly processed so as to result in errors in some applications.

In media streaming applications, before transmission of a media stream, control signals, such as those associated with various protocols including session initiation protocol (SIP), media gateway control protocol (MGCP), H.323 signaling protocol, etc., are used by the two transmission ends of a media streaming connection to acquire information of the addresses and ports of the other party. The media streaming connection information usually is included in the content of the control signal protocols. However, when transmitting the end address of the transmission end, the network address translator will not modify the media streaming information content of the control signals. As a result, this causes transmission failure of the media stream.

Some solutions are used in an attempt to resolve such a problem, such as implementation of an application level gateway of a network address translator to modify the content of the application layer packet so as to establish a normal connection for a media stream. Nevertheless, there are still many problems for the application layer gateway, such as an inability to receive a media stream sent from an external location, transmission failure of a media stream caused by modification errors in the content of the application layer packet, etc. There are also other disclosed solutions, such as a method using middlebox communications (MIDCOM) or a method of Simple Traversal of User datagram protocol through Network address translators (STUN). However, these two methods need to be established over proprietary protocols and also by using extra servers so as to establish normal connection for a media stream.

### SUMMARY OF THE INVENTION

Therefore, the object of the present invention is to provide a network address translation method, a network address translator, and a communication system for media streaming, in which a normal network connection for a media stream is established through the use of a network address translator, rather than through the use of additional servers.

According to a first aspect, the network address translation method for media streaming is implemented using a network address translator connected to a first user end, the network address translator enabling the first user end to be connected to a second user end via a control signal server. The network address translation method comprises:

(a) configuring the network address translator to receive a first control signal sent by the first user end indicating an intent to conduct media streaming, a media description in the first control signal including a private first address and a private first port, the network address translator being configured to record the first address and the first port;

(b) configuring the network address translator to modify the first address and the first port of the media description in the first control signal to a public second address and a public second port, respectively, and to subsequently send a second control signal containing a media description that includes the second address and the second port to the control signal server, so as to invite establishment of a media streaming connection with the second user end; and

(c) configuring the network address translator to
receive a third control signal from the second user end via the control signal server, the third control signal being sent in response to the invitation to establish a media streaming connection,
parse a media description in the third control signal to obtain a public third address and a public third port, and
establish an address translation rule for media streaming according to the first address, the second address, the third address, the first port, the second port, and the third port, such that a media streaming connection may be established via the Internet between the first user end and the second user end.

According to a second aspect, the network address translation method for media streaming is implemented using a network address translator connected to a first user end, the network address translator enabling the first user end to be connected to a second user end via a control signal server. The network address translation method comprises:

(a) configuring the network address translator to receive a fourth control signal from the second user end indicating an intent to conduct media streaming, record a public fourth address and a public fourth port of a media description in the fourth control signal, and send the fourth control signal to the first user end so as to invite establishment of a media streaming connection with the second user end;

(b) configuring the network address translator to
receive a fifth control signal from the first user end, the fifth control signal being sent in response to the invitation to establish a media streaming connection,
modify a private fifth address and a private fifth port of a media description in the fifth control signal to a public sixth address and a public sixth port, respectively, and
record the fifth address, the fifth port, the sixth address, and the sixth port; and

(c) configure the network address translator to send a sixth control signal containing a media description that includes the sixth address and the sixth port to the second user end, so as to respond to the invitation to establish a media streaming connection, and establish an address translation rule according to recorded ones of the fourth address, the fifth address, the sixth address, the fourth port, the fifth port, and the sixth port, such that a media streaming connection may be established via the Internet between the first user end and the second user end.

According to a third aspect, a network address translator for media streaming is configured for connecting to a first user end, and enables the first user end to establish a media streaming connection with a second user end via a control signal server. The network address translator comprises:

a first network transmission unit for receiving a first control signal sent by the first user end indicating an intent to conduct media streaming;

a second network transmission unit for receiving a third control signal from the second user end via the control signal server, and sending a second control signal to the second user end via the control signal server to invite establishment of a media streaming connection;

a memory unit;

a parsing module for parsing a private first address and a private first port from a media description in the first control signal received from the first network transmission unit, and a public third address and a public third port from a media description in the third control signal received from the second network transmission unit;

a modifying module for modifying the first address and the first port of the media description in the first control signal to a public second address and a public second port, respectively;

a controlling module for controlling the memory unit to record the first address, the second address, the third address, the first port, the second port, and the third port, and controlling the second network transmission unit to send the second control signal to the second user end, a media description in the second control signal including the second address and the second port; and
an address translation module for establishing a first address translation rule according to the first address, the second address, the third address, the first port, the second port, and the third port recorded in the memory unit, such that a media streaming connection may be established via the Internet between the first user end and the second user end.

According to a fourth aspect, a communication system for media streaming comprises:

a first user end for sending a first control signal indicating an intent to conduct media streaming, a media description in the first control signal including a private first address and a private first port;

a second user end for receiving a second control signal for inviting establishment of a media streaming connection, and sending a third control signal containing a media description that includes a public third address and a public third port;

a network address translator coupled to the first user end and receiving the first control signal therefrom, parsing the first address and the first port from the media description in the first control signal, modifying the first address and the first port to a public second address and a public second port, sending the second control signal including the public second address and the public second port in a media description thereof to the second user end, receiving the third control signal sent in response by the second user end, and establishing a first address translation rule according to the first address, the second address, the third address, the first port, the second port, and the third port, such that a media streaming connection may be established via the Internet between the first user end and the second user end; and

a control signal server coupled to the network address translator and the second user end via the Internet, the first user end being coupled to the second user end via the network address translator and the Internet.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram illustrating a communication system for media streaming according to a preferred embodiment of the present invention;

FIG. 2 is a schematic circuit block diagram of a network address translator for media streaming according to a preferred embodiment of the present invention;

FIG. 3 is a flow chart of an exemplary embodiment of a network address translation method for media streaming according to the present invention; and

FIG. 4 is a flow chart of another exemplary embodiment of a network address translation method for media streaming according to the present invention.

### DETAILED DESCRIPTION OF THE PREFERRED EMBODIMENT

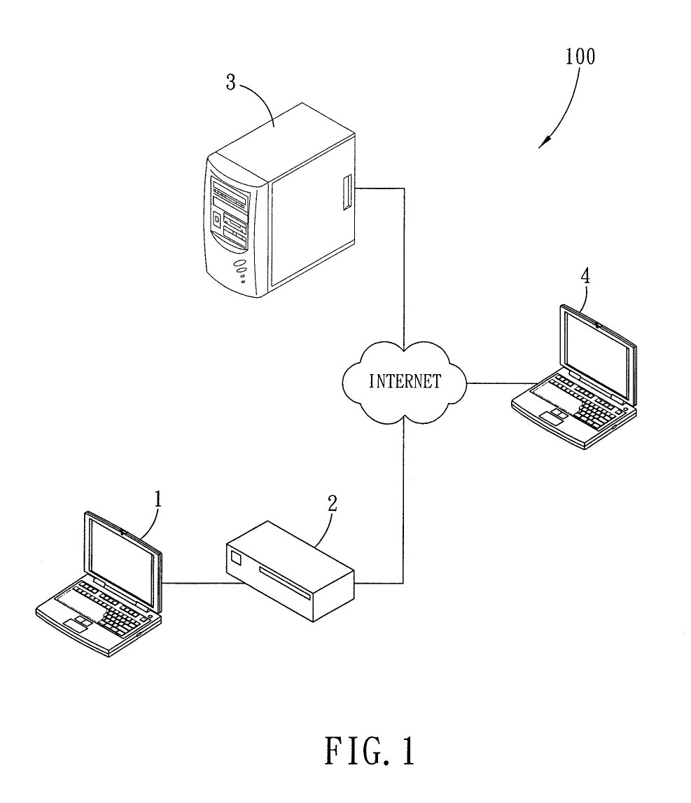

As shown in FIG. 1, the preferred embodiment of a communication system 100 for media streaming according to the present invention comprises a first user end 1, a second user end 4, a network address translator 2, and a control signal server 3. The first user end 1 is connected to the network address translator 2, such as through an RJ45 wiring connection or through a private network connection. Each of the network address translator 2 and the second user end 4 is connected to the control signal server 3 via the Internet, such that the first user end 1 is indirectly connected to the second user end 4 via the network address translator 2 and the Internet so as to establish a multimedia streaming connection with second user end 4.

It is to be noted herein that various different types of content forms may be involved in media streaming referred to herein, such as any one or a combination of audio, video image, and still image data. In some embodiments, the media streams are live. In other embodiments, the media streams are first saved before being streamed. The communication system 100 of this invention may be structured based on one of session initiation protocol (SIP), media gateway control protocol (MGCP), and H.323 signaling protocol, and uses the control signals of SIP, MGCP, and H.323 signaling protocol to establish a media stream. Hence, the communication system 100 of the present invention may be used to realize media streaming for Internet television, to enjoy video and/or audio streams using a browser to watch images or listen to audio, and to facilitate video conferencing, VOIP, and FOIP, etc. However, the communication system 100 of this invention is not restricted in this regard. In this embodiment, a description is provided in which the communication system 100 is structured based on SIP, and hence, the first user end 1 and the second user end 4 are SIP users, the control signal server 3 is an SIP network server, and the network address translator 2 uses a Linux® operating system.

Moreover, media descriptions in control signals can be parsed. Using messages of SIP and MGCP protocols as an example, the media descriptions thereof use session description protocol (SDP) packets with the primary purpose of allowing the two parties of a session to know, through the packets, detailed information, such as IP addresses, connection ports, etc., needed to establish a session. Therefore, regardless of whether SIP protocol messages or MGCP protocol messages are used, SDP packets are parsed to obtain information in media descriptions.

The first user end 1 is able to send a first control signal of a media stream to the network address translator 2. The media description in the first control signal can be parsed into a first address and a first port. The second user end 4 receives a second control signal from the control signal server 3 that is used to invite establishment of a media streaming connection, and sends a third control signal in response to the invitation to the control signal server 3. Similarly, the media description in the third control signal can be parsed into a third address and a third port by the network address translator 2. In this embodiment, the third address and the third port are a public address and a public port, respectively. That is, in this embodiment, the second user end 4 is connected to a public network. Moreover, the first address and the first port are a private address and a private port, respectively. That is, in this embodiment, the first user end 1 is connected to a private network.

In some embodiments, the second user end 4 may send an invitation for establishing a multimedia streaming connection. An example of such an embodiment will also be described.

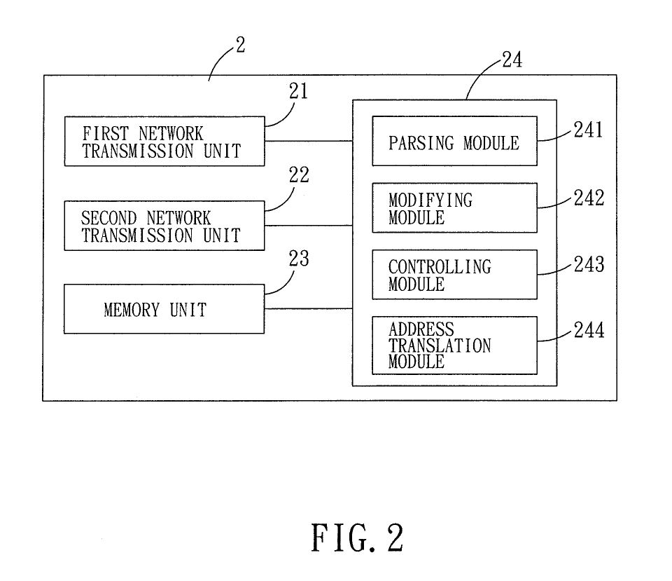

Referring to FIG. 2, the network address translator 2 comprises a first network transmission unit 21, a second network transmission unit 22, a memory unit 23, and a processing unit 24.

The first network transmission unit 21 receives data from and transmits data to the first user end 1, such as receiving a first control signal of a media stream sent by the first user end 1 (i.e., the first network transmission unit 21 is able to receive and transmit media stream control signals). In this embodiment, the first network transmission unit 21 is an Ethernet physical interface.

The second network transmission unit 22 receives data from and transmits data to the second user end 4 via the Internet and the control signal server 3, such as receiving the third control signal from the second user end 4 via the control signal server 3 and sending the second control signal to the second user end 4 via the control signal server 3 to invite establishing a media streaming connection (i.e., the second network transmission unit 22 is able to receive and transmit media stream control signals). In this embodiment, the second network transmission unit 22 is an Internet physical interface.

The memory unit 23 is used for recording received and transmitted network signal data, such as IP addresses, connection ports, etc. In this embodiment, the memory unit 23 includes a flash memory and a synchronous dynamic random access memory (SDRAM), but is not limited in this regard.

The processing unit 24 comprises a parsing module 241, a modifying module 242, a controlling module 243, and an address translation module 244. In some embodiments, each of the modules of the processing unit 24 is realized using software.

The parsing module 241 parses addresses and ports from the media descriptions in the control signals of the media stream, for example, a first address and a first port from the media description in the first control signal received from the first network transmission unit 21, and a third address and a third port from the media description in the third control signal received from the second network transmission unit 22. It is noted that “address” as used herein may be an “IP address.”

The modifying module 242 is able to modify private addresses and ports to public addresses and ports. For example, the modifying module 242 modifies the first address and the first port of the media description in the first control signal to a second address and a second port, respectively. It is to be noted that the second address and the second port are respectively a public address and a public port of the network address translator 2, that is, the second address and the second port can be used in a public network.

The controlling module 243 controls the memory unit 23 to record addresses and ports, and further controls the first and second network transmission units 21, 22 to send control signals to respond to or invite establishing a media streaming connection. For example, the controlling module 243 controls the memory unit 23 to record the first address, the second address, the third address, the first port, the second port, and the third port, and controls the second network transmission unit 22 to transmit the second control signal, in which the media description in the second control signal includes the second address and the second port.

The address translation module 244 establishes an address translation rule according to the addresses and the ports recorded in the memory unit 23. That is, when the network address translator 2 receives a packet sent to the third port of the third address from the first port of the first address, the network address translator 2 translates the packet address of the packet as one to be sent to the third port of the third address from the second port of the second address, and when the network address translator 2 receives a packet sent to the second port of the second address from the third port of the third address, the network address translator 2 translates the packet as one to be sent to the first port of the first address from the third port of the third address, such that the packets from the first user end 1 and the second user end 4 can be transmitted between the private and public networks to thereby successfully establish a media streaming connection.

Exemplary embodiments of the network address translation method for media streaming of this invention will now be described.

First, an example is given in which the first user end 1, which is in the private domain, invites the second user end 4, which is in the public domain, to establish a media streaming connection.

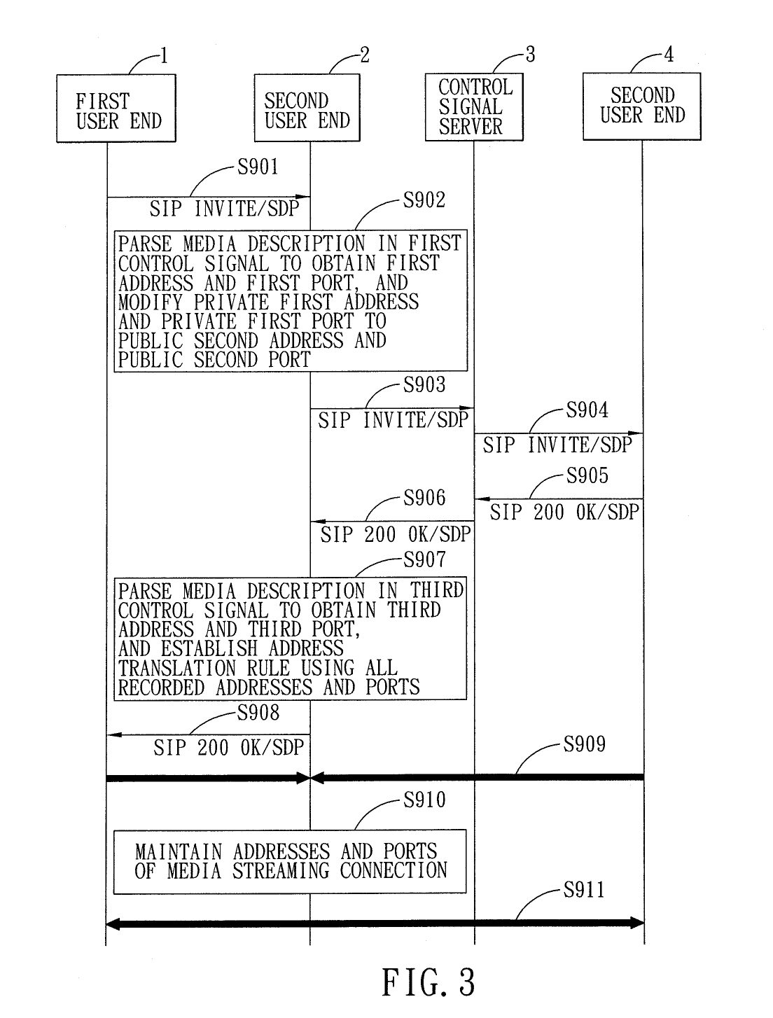

Referring to FIGS. 1, 2, and 3, in step S901, the first user end 1 sends the first control signal for inviting establishment of a media streaming connection to the network address translator 2, such as INVITE/SDP of the SIP communication protocol, in which the media description in the first control signal includes the first address and the first port.

When the packet reaches the network address translator 2, in step S902, the first network transmission unit 21 of the network address translator 2 receives the first control signal, and the parsing module 241 of the processing unit 24 parses the media description in the first control signal so as to obtain the first address and the first port, after which the modifying module 242 modifies the private first address and the private first port in the media description to a public second address and a public second port, respectively, and the controlling module 243 instructs the memory unit 23 to record the first address, the second address, the first port, and the second port.

In step S903, the controlling module 243 instructs the second network transmission unit 22 to send the modified second control signal to the control signal server 3 for inviting establishment of a media streaming connection, such as INVITE/SDP of the SIP communication protocol, in which the media description in the second control signal includes the public second address and the public second port.

Next, in step S904, the control signal server 3 sends the second control signal, which is received from the network address translator 2, to the second user end 4 for inviting establishment of a media streaming connection, such as INVITE/SDP of the SIP communication protocol.

After the second user end 4 receives the invitation to establish a media streaming connection, in step S905, the second user end 4 sends the third control signal to the control signal server 3 in response to the invitation, such as 200 OK/SDP of the SIP communication protocol, in which the media description in the third control signal includes the public third address and the public third port.

In step S906, the control signal server 3 sends the third control signal having the OK response to the network address translator 2.

Next, in step S907, the second network transmission unit 22 of the network address translator 2 receives the third control signal sent in response from the second user end 4, the parsing module 241 of the processing unit 24 parses the media description in the third control signal so as to obtain the third address and the third port, and the controlling module 243 instructs the memory unit 23 to record the third address and the third port. Hence, the memory unit 23 has recorded therein the first address, the second address, the third address, the first port, the second port, and the third port, so that the address translation module 244 can establish an address translation rule (also referred to herein as a “first address translation rule”) according to the addresses and ports recorded in the memory unit 23.

As described above, the first address translation rule is established such that: when the network address translator 2 receives a packet sent to the third port of the third address from the first port of the first address, the network address translator 2 translates the packet address of the packet as one to be sent to the third port of the third address from the second port of the second address; and when the network address translator 2 receives a packet sent to the second port of the second address from the third port of the third address, the network address translator 2 translates the packet as one to be sent to the first port of the first address from the third port of the third address, such that the packets from the first user end 1 and the second user end 4 can be transmitted between private and public networks to thereby establish said media streaming connection.

After the address translation rule is established, in step S908, the first network transmission unit 21 of the network address translator 2 sends the OK response to the invitation for the media streaming connection received from the second user end 4 to the first user end 1 for confirmation of the media streaming connection.

Thus, in step S909, the first user end 1 and the second user end 4 start to send media streaming data to each other, such as through use of the real-time transmission protocol (RTP).

Subsequently, since the network address translator 2 has successfully established the address translation rule, instep S910, the addresses and ports of the media streaming connection may be maintained, and, in step S911, the media streaming packets can successfully transmit between the private and public networks.

A further example is given in which the second user end 4, which is in the public domain, invites the first user end 1, which is in the private domain, to establish a media streaming connection.

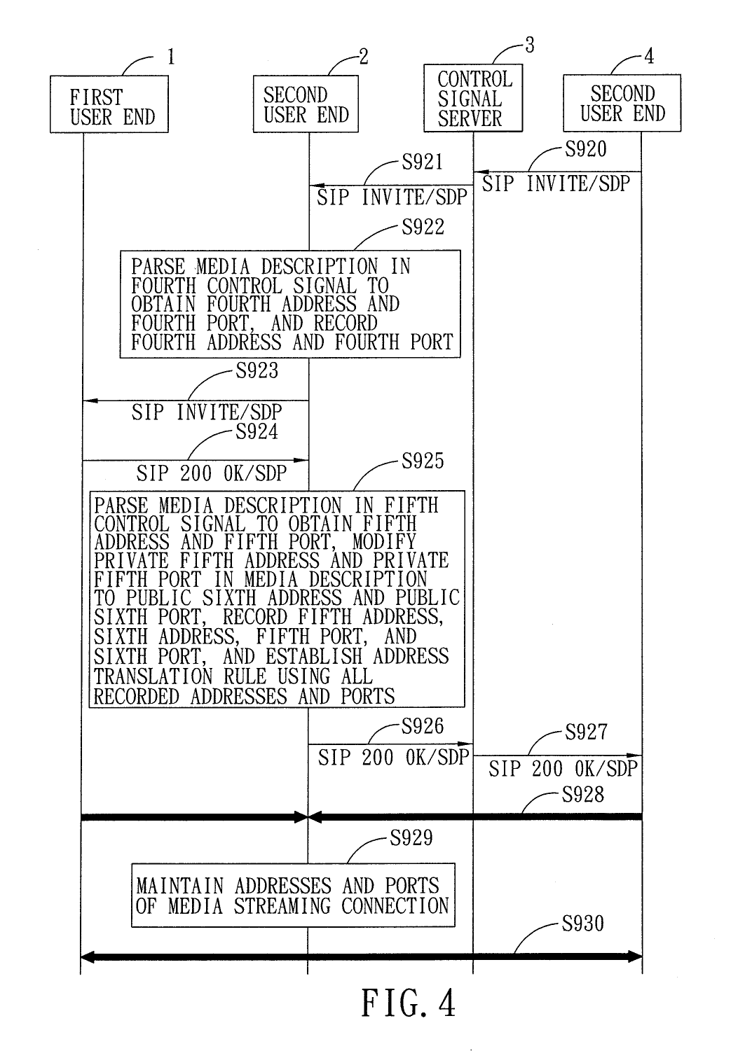

Referring to FIGS. 1, 2, and 4, in steps S920 and S921, the second user end 4 sends a fourth control signal for inviting establishment of a media streaming connection to the first user end 1 via the control signal server 3 and the network address translator 2, such as INVITE/SDP of the SIP communication protocol, in which a media description in the fourth control signal includes a fourth address and a fourth port.

Next, in step S922, when the packet reaches the network address translator 2, the second network transmission unit 22 of the network address translator 2 receives the fourth control signal, and the parsing module 241 of the processing unit 24 parses the media description in the fourth control signal so as to obtain the fourth address and the fourth port, after which the controlling module 243 instructs the memory unit 23 to record the fourth address and the fourth port.

Next, in step S923, the controlling module 243 instructs the first network transmission unit 21 to send the fourth control signal to the first user end 1 to invite establishment of a media streaming connection, such as INVITE/SDP of the SIP communication protocol.

Next, after receiving the invitation to establish a media streaming connection, in step S924, the first user end 1 sends a fifth control signal to the network address translator 2 in response to the invitation, such as 200 OK/SDP of the SIP communication protocol, in which a media description in the fifth control signal includes a private fifth address and a private fifth port.

In step S925, when this packet reaches the network address translator 2, the first network transmission unit 21 of the network address translator 2 receives the fifth control signal, the parsing module 241 of the processing unit 24 parses the media description in the fifth control signal so as to obtain the fifth address and the fifth port, after which the modifying module 242 modifies the private fifth address and the private fifth port in the media description to a public sixth address and a public sixth port, respectively, and the controlling module 243 instructs the memory unit 23 to record the fifth address, the sixth address, the fifth port, and the sixth port. The fourth address, the fifth address, the sixth address, the fourth port, the fifth port, and the sixth port are recorded so that the address translation module 244 can establish an address translation rule (also referred to herein as a “second address translation rule”) according to the addresses and ports recorded in the memory unit 23.

The second address translation rule is established such that: when the network address translator 2 receives a packet sent to the sixth port of the sixth address from the fourth port of the fourth address, the network address translator 2 translates the packet address of the packet as one to be sent to the fifth port of the fifth address from the fourth port of the fourth address; and when the network address translator 2 receives a packet sent to the fourth port of the fourth address from the fifth port of the fifth address, the network address translator 2 translates the packet as one to be sent to the fourth port of the fourth address from the sixth port of the sixth address, such that the packets from the first user end 1 and the second user end 4 can be transmitted between private and public networks to thereby establish said media streaming connection.

Next, in step S926, the controlling module 243 instructs the second network transmission unit 22 to send a sixth control signal to the control signal server 3 in response to the invitation by the second user end 4, such as 200 OK/SDP of the SIP communication protocol, in which a media description in the sixth control signal includes the public sixth address and the public sixth port.

In step S927, the control signal server 3 sends the OK response to the invitation for the media streaming connection received from the first user end 1 to the second user end 4 for confirmation of the media streaming connection.

Thus, in step S928, the second user end 4 and the first user end 1 start to send media streaming data to each other, such as through the real-time transmission protocol (RTP).

Subsequently, since the network address translator 2 has successfully established the address translation rule, in step S929, the addresses and ports of the media streaming connection may be maintained, and, in step S930, the media streaming packets can successfully transmit between the private and public networks.

Hence, the network address translator 2 that utilizes the network address translation method of this invention is capable of parsing control signal packets passing therethrough so as to obtain the addresses and ports in the media description thereof for realizing a media streaming connection, after which the network address translator 2 modifies the private addresses and ports in the media descriptions to the public addresses and ports, and establishes the address translation rules according to the recorded addresses and ports so as to ensure successful media streaming connection between the first user end 1 and the second user end 4. In contrast to the conventional network address translator that has only a single address and port translation function and no integration function to ensure accurate media streaming connection, or that requires an additional external server to ensure accurate media streaming connection, the network address translator of this invention has the advantages of integrating address and port information to ensure accurate media streaming connection, and does not require an additional external server.

It is to be noted that if the second user end 4 is also connected to a network address translator disposed between the second user end 4 and the control signal server 3, then the same method can be used by such a network address translator disposed between the second user end 4 and the control signal server 3. That is, such a network address translator would be able to translate the private addresses and ports of the media descriptions in the control signals of the second user end 4 to public addresses and ports, and thus, would be able to establish a media streaming connection with the first user end 1 through the Internet.

The communication system 100 for media streaming of this invention uses the network address translator 2 to implement the network address translation method for media streaming of the present invention such that the first user end 1 located in the private domain can accurately establish a media streaming connection with the second user end 4 located in the public domain through use of the control signal server 3, as well as the network address translator 2 (i.e., the integration function of the network address translator 2).

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A network address translation method for media streaming to be implemented using a network address translator connected to a first user end, the network address translator enabling the first user end to be connected to a second user end via a control signal server, said network address translation method comprising:
(a) configuring the network address translator to receive a first control signal sent by the first user end indicating an intent to conduct media streaming, a media description in the first control signal including a private first address and a private first port, the network address translator being configured to record the first address and the first port;
(b) configuring the network address translator to modify the first address and the first port of the media description in the first control signal to a public second address and a public second port, respectively, and to subsequently send a second control signal containing a media description that includes the second address and the second port to the control signal server, so as to invite establishment of a media streaming connection with the second user end; and
(c) configuring the network address translator to
receive a third control signal from the second user end via the control signal server, the third control signal being sent in response to the invitation to establish a media streaming connection,
parse a media description in the third control signal to obtain a public third address and a public third port, and
establish an address translation rule according to the first address, the second address, the third address, the first port, the second port, and the third port, such that a media streaming connection may be established via the Internet between the first user end and the second user end.

2. The network address translation method of claim 1, wherein the media streaming connection is established based on one of session initiation protocol (SIP), media gateway control protocol (MGCP), and H.323 signaling protocol.

3. The network address translation method of claim 1, wherein the network address translator uses a Linux® operating system.

4. The network address translation method of claim 1, wherein the address translation rule is established such that:
when the network address translator receives a packet sent to the third port of the third address from the first port of the first address, the network address translator translates the packet address of the packet as one to be sent to the third port of the third address from the second port of the second address; and
when the network address translator receives a packet sent to the second port of the second address from the third port of the third address, the network address translator translates the packet as one to be sent to the first port of the first address from the third port of the third address, such that the packets from the first user end and the second user end can be transmitted between private and public networks to thereby establish said media streaming connection.

5. A network address translation method for media streaming to be implemented using a network address translator connected to a first user end, the network address translator enabling the first user end to be connected to a second user end via a control signal server, said network address translation method comprising:
(a) configuring the network address translator to receive a fourth control signal from the second user end indicating an intent to conduct media streaming, record a public fourth address and a public fourth port of a media description in the fourth control signal, and send the fourth control signal to the first user end so as to invite establishment of a media streaming connection with the second user end;
(b) configuring the network address translator to
receive a fifth control signal from the first user end, the fifth control signal being sent in response to the invitation to establish a media streaming connection,
modify a private fifth address and a private fifth port of a media description in the fifth control signal to a public sixth address and a public sixth port, respectively, and
record the fifth address, the fifth port, the sixth address, and the sixth port; and
(c) configure the network address translator to send a sixth control signal containing a media description that includes the sixth address and the sixth port to the second user end, so as to respond to the invitation to establish a media streaming connection, and establish an address translation rule according to recorded ones of the fourth address, the fifth address, the sixth address, the fourth port, the fifth port, and the sixth port, such that a media streaming connection may be established via the Internet between the first user end and the second user end.

6. The network address translation method of claim 5, wherein the media streaming connection is established based on one of session initiation protocol (SIP), media gateway control protocol (MGCP), and H.323 signaling protocol.

7. The network address translation method of claim 5, wherein the network address translator uses a Linux® operating system.

8. The network address translation method of claim 5, wherein the address translation rule is established such that:
when the network address translator receives a packet sent to the sixth port of the sixth address from the fourth port of the fourth address, the network address translator translates the packet address of the packet as one to be sent to the fifth port of the fifth address from the fourth port of the fourth address; and
when the network address translator receives a packet sent to the fourth port of the fourth address from the fifth port of the fifth address, the network address translator translates the packet as one to be sent to the fourth port of the fourth address from the sixth port of the sixth address, such that the packets from the first user end and the second user end can be transmitted between private and public networks to thereby establish said media streaming connection.

9. A network address translator for media streaming, said network address translator being configured for connecting to a first user end, and enabling the first user end to establish a media streaming connection with a second user end via a control signal server, said network address translator comprising:
a first network transmission unit for receiving a first control signal sent by the first user end indicating an intent to conduct media streaming;
a second network transmission unit for receiving a third control signal from the second user end via the control signal server, and sending a second control signal to the second user end via the control signal server to invite establishment of a media streaming connection;
a memory unit;
a parsing module for parsing a private first address and a private first port from a media description in the first control signal received from said first network transmission unit, and a public third address and a public third port from a media description in the third control signal received from said second network transmission unit;
a modifying module for modifying the first address and the first port of the media description in the first control signal to a public second address and a public second port, respectively;
a controlling module for controlling said memory unit to record the first address, the second address, the third address, the first port, the second port, and the third port, and controlling said second network transmission unit to send the second control signal to the second user end, a media description in the second control signal including the second address and the second port; and
an address translation module for establishing a first address translation rule according to the first address, the second address, the third address, the first port, the second port, and the third port recorded in said memory unit, such that a media streaming connection may be established via the Internet between the first user end and the second user end.

10. The network address translator of claim 9, wherein:
said second network transmission unit further receives a fourth control signal from the second user end indicating an intent to conduct media streaming;
said first network transmission unit further sends the fourth control signal to the first user end so as to invite establishment of a media streaming connection, and receives a fifth control signal from the first user end, the fifth control signal being sent in response to the invitation to establish a media streaming connection;
said parsing module further parses a public fourth address and a public fourth port from a media description in the fourth control signal, and a private fifth address and a private fifth port from a media description in the fifth control signal;
said modifying module modifies the fifth address and the fifth port of the media description in the fifth control signal to a public sixth address and a public sixth port, respectively;
said controlling module controls said memory unit to record the fourth address, the fifth address, the sixth address, the fourth port, the fifth port, and the sixth port, and controls said second network transmission unit to send the sixth control signal to the second user end to thereby respond to the invitation to establish a media streaming connection, a media description in the sixth control signal including the sixth address and the sixth port; and
said address translation module establishes a second address translation rule according to the fourth address, the fifth address, the sixth address, the fourth port, the fifth port, and the sixth port recorded in said memory unit, such that a media streaming connection may be established via the Internet between the first user end and the second user end.

11. The network address translator of claim 10, wherein the media streaming connection is established based on one of session initiation protocol (SIP), media gateway control protocol (MGCP), and H.323 signaling protocol.

12. The network address translator of claim 10, wherein said network address translator uses a Linux® operating system.

13. The network address translator of claim 10, wherein the first address translation rule is established such that:
when said network address translator receives a packet sent to the third port of the third address from the first port of the first address, said network address translator translates the packet address of the packet as one to be sent to the third port of the third address from the second port of the second address; and
when said network address translator receives a packet sent to the second port of the second address from the third port of the third address, said network address translator translates the packet as one to be sent to the first port of the first address from the third port of the third address, such that the packets from the first user end and the second user end can be transmitted between private and public networks to thereby establish said media streaming connection; and
the second address translation rule is established such that:
when said network address translator receives a packet sent to the sixth port of the sixth address from the fourth port of the fourth address, said network address translator translates the packet address of the packet as one to be sent to the fifth port of the fifth address from the fourth port of the fourth address; and
when said network address translator receives a packet sent to the fourth port of the fourth address from the fifth port of the fifth address, said network address translator translates the packet as one to be sent to the fourth port of the fourth address from the sixth port of the sixth address, such that the packets from the first user end and the second user end can be transmitted between private and public networks to thereby establish said media streaming connection.

14. The network address translator of claim 9, wherein the first address translation rule is established such that:
when said network address translator receives a packet sent to the third port of the third address from the first port of the first address, said network address translator translates the packet address of the packet as one to be sent to the third port of the third address from the second port of the second address; and
when said network address translator receives a packet sent to the second port of the second address from the third port of the third address, said network address translator translates the packet as one to be sent to the first port of the first address from the third port of the third address, such that the packets from the first user end and the second user end can be transmitted between private and public networks to thereby establish said media streaming connection.

15. A communication system for media streaming, said communication system comprising:
a first user end for sending a first control signal indicating an intent to conduct media streaming, a media description in the first control signal including a private first address and a private first port;
a second user end for receiving a second control signal for inviting establishment of a media streaming connection, and sending a third control signal containing a media description that includes a public third address and a public third port;
a network address translator coupled to said first user end and receiving the first control signal therefrom, parsing the first address and the first port from the media description in the first control signal, modifying the first address and the first port to a public second address and a public second port, sending the second control signal including the public second address and the public second port in a media description thereof to said second user end, receiving the third control signal sent in response by the second user end, and establishing a first address translation rule according to the first address, the second address, the third address, the first port, the second port, and the third port, such that a media streaming connection may be established via the Internet between said first user end and said second user end; and
a control signal server coupled to said network address translator and said second user end via the Internet, said first user end being coupled to said second user end via said network address translator and the Internet.

16. The communication system of claim 15, wherein said network address translator includes:
a first network transmission unit for receiving the first control signal sent by said first user end;
a second network transmission unit for receiving the third control signal from said second user end, and sending the second control signal to said second user end to invite establishment of a media streaming connection;
a memory unit;
a parsing module for parsing the first address and the first port from the media description in the first control signal received from said first network transmission unit, and the third address and the third port from the media description in the third control signal received from said second network transmission unit;
a modifying module for modifying the first address and the first port of the media description in the first control signal to the second address and the second port, respectively;
a controlling module for controlling said memory unit to record the first address, the second address, the third address, the first port, the second port, and the third port; and
an address translation module for establishing the first address translation rule according to the addresses and the ports recorded in said memory unit, such that a media streaming connection is established between said first user end and said second user end.

17. The communication system of claim 16, wherein:
said second network transmission unit further receives a fourth control signal from said second user end indicating an intent to conduct media streaming;
said first network transmission unit further sends the fourth control signal to said first user end so as to invite establishment of a media streaming connection, and receives a fifth control signal from said first user end, the fifth control signal being sent in response to the invitation to establish a media streaming connection;
said parsing module further parses a public fourth address and a public fourth port from a media description in the fourth control signal, and a private fifth address and a private fifth port from a media description in the fifth control signal;
said modifying module modifies the fifth address and the fifth port of the media description in the fifth control signal to a public sixth address and a public sixth port, respectively;
said controlling module controls said memory unit to record the fourth address, the fifth address, the sixth address, the fourth port, the fifth port, and the sixth port, and controls said second network transmission unit to send the sixth control signal to said second user end to thereby respond to the invitation to establish a media streaming connection, a media description in the sixth control signal including the sixth address and the sixth port; and
said address translation module establishes a second address translation rule according to the fourth address, the fifth address, the sixth address, the fourth port, the fifth port, and the sixth port recorded in said memory unit, such that a media streaming connection may be established via the Internet between said first user end and said second user end.

18. The communication system of claim 17, wherein the media streaming connection is established based on one of session initiation protocol (SIP), media gateway control protocol (MGCP), and H.323 signaling protocol.

19. The communication system of claim 17, wherein said network address translator uses a Linux® operating system.

20. The communication system of claim 17, wherein the first address translation rule is established such that:
when said network address translator receives a packet sent to the third port of the third address from the first port of the first address, said network address translator translates the packet address of the packet as one to be sent to the third port of the third address from the second port of the second address; and
when said network address translator receives a packet sent to the second port of the second address from the third port of the third address, said network address translator translates the packet as one to be sent to the first port of the first address from the third port of the third address, such that the packets from said first user end and said second user end can be transmitted between private and public networks to thereby establish said media streaming connection; and
the second address translation rule is established such that:
when said network address translator receives a packet sent to the sixth port of the sixth address from the fourth port of the fourth address, said network address translator translates the packet address of the packet as one to be sent to the fifth port of the fifth address from the fourth port of the fourth address; and
when said network address translator receives a packet sent to the fourth port of the fourth address from the fifth port of the fifth address, said network address translator translates the packet as one to be sent to the fourth port of the fourth address from the sixth port of the sixth address, such that the packets from said first user end and said second user end can be transmitted between private and public networks to thereby establish said media streaming connection.

21. The communication system of claim 15, wherein the first address translation rule is established such that:
when said network address translator receives a packet sent to the third port of the third address from the first port of the first address, said network address translator translates the packet address of the packet as one to be sent to the third port of the third address from the second port of the second address; and
when said network address translator receives a packet sent to the second port of the second address from the third port of the third address, said network address translator translates the packet as one to be sent to the first port of the first address from the third port of the third address, such that the packets from said first user end and said second user end can be transmitted between private and public networks to thereby establish said media streaming connection.
